(19) United States
(12) Patent Application Publication
(10) Pub. No.: US 2024/0224141 A1
(43) Pub. Date: Jul. 4, 2024

(54) WIRELESS TERMINAL, METHOD FOR CONNECTING WIRELESS TERMINAL AND PROGRAM FOR CONTROLLING CONNECTION

(71) Applicant: RAKUTEN MOBILE, INC., Tokyo (CN)

(72) Inventors: Hiroshi TAKESHITA, Tokyo (JP); Takeshi USUI, Tokyo (JP); Hiroyuki ITO, Tokyo (JP)

(73) Assignee: RAKUTEN MOBILE, INC., Tokyo (JP)

(21) Appl. No.: 17/918,710

(22) PCT Filed: Aug. 27, 2021
(86) PCT No.: PCT/JP2021/031544

§ 371 Date: Oct. 13, 2022

(51) Int. Cl. H04W 36/08; H04W 76/19; H04W 76/20

(52) U.S. Cl. CPC H04W 36/08; H04W 76/19; H04W 76/20

(57) ABSTRACT

Provided is a radio terminal that operates in a service area having a first cell and a second cell, the radio terminal comprising: a timer; a communication status acquisition unit that acquires a communication status of the radio terminal when an expiration period expires in the timer; a connection possibility determination unit that determines whether or not connection to the first cell is possible if the communication status is an idle state; a control unit that sequentially acquires the expiration period from a sequence of expiration periods and that repeatedly operates the communication status acquisition unit and the connection possibility determination unit until the communication status is in an idle state and connection to the first cell is determined to be possible; and a connection unit that connects to the first cell if connection to the first cell is determined to be possible.

### TECHNICAL FIELD

The present invention relates to a radio terminal, a method for controlling a connection of a radio terminal, and a program for controlling a connection for a radio terminal.

### BACKGROUND

In a radio access network having a primary network and a partner network, if a radio terminal supports both the primary network and the partner network, then roaming communication using the partner network is possible even in a case in which the radio terminal is in a region in which the primary network cannot be used.

Non-Patent Document 1 discloses roaming between a primary network area and a partner network area.

### CITATION LIST

### Non-Patent Literature

Non-Patent Document 1: 3GPP TS 22.011 V17.3.0 (2020 December)
Non-Patent Document 2: ETSI TS 131 102 V16.7.0 (2021 August)

### SUMMARY OF INVENTION

### Technical Problem

Even in the case in which a radio terminal has selected a partner network and is performing roaming communication, communication with a base station belonging to a primary network may also become possible due to movement of the radio terminal or the like. Furthermore, in cases in which there is an advantage to using the primary network over the partner network, it is desirable to return to using the primary network as soon as possible.

However, in order to generate instructions from a base station belonging to a partner network to a radio terminal that is connected to the base station so as to make the radio terminal re-select a connection to another base station belonging to a primary network, the base station belonging to the partner network must be provided with a setting for generating such instructions. Since a carrier operating a partner network normally differs from a carrier operating a primary network, the primary network carrier would need to request the partner network carrier to change the settings in the base station.

Meanwhile, there was a problem, e.g., in that making a radio terminal constantly perform searches for the possibility of using the primary network in order to return to using the primary network as soon as possible leads to consumption of the batteries in the radio terminal.

Additionally, Non-Patent Document 1 describes that a radio terminal attempts to re-select the connection destination network periodically at fixed intervals, the interval being set to be every 6 minutes. Non-Patent Document 2 describes setting the period by which searches for high-priority communication networks are to be attempted by means of an EFHPPLMN in a Universal Subscriber Identity Module (USIM). Improvements in setting methods such as these are desired for the purpose of quickly returning to primary network.

The present invention was made in view of the circumstances described above, and an objective of the present invention is to provide, in a radio terminal supporting both a primary network and a partner network, technology for re-selecting the primary network, with low power consumption and at high speed, from the partner network that is selected.

### Solution to Problem

One embodiment of the radio terminal according to the present invention is a radio terminal that operates in a service area having a first cell and a second cell, the radio terminal comprising: a timer; a communication status acquisition unit that acquires a communication status of the radio terminal when an expiration period expires in the timer; a connection possibility determination unit that determines whether or not connection to the first cell is possible if the communication status is an idle state; a control unit that sequentially acquires the expiration period from a sequence of expiration periods and that repeatedly operates the communication status acquisition unit and the connection possibility determination unit until the communication status is in an idle state and connection to the first cell is determined to be possible; and a connection unit that connects to the first cell if connection to the first cell is determined to be possible.

The sequence of expiration periods may be a sequence in which numbers become gradually larger.

The radio terminal may be configured so that, if the timer is instructed to be reset, the acquisition of the expiration periods is performed sequentially after returning to the head of the sequence of expiration periods.

The radio terminal may be configured so that the timer is instructed to be reset when an area code acquired from a base station is changed. The radio terminal may be configured so that the timer is instructed to be reset when power to the radio terminal is switched back on. The radio terminal may be configured so that the timer is instructed to be reset when data transmission by the radio terminal is resumed.

The radio terminal may be configured so that, when a connection between the radio terminal and the second cell is lost, if connection to the first cell is determined to be possible, the radio terminal is connected to the first cell, and if connection to the first cell is not determined to be possible, the timer is instructed to be reset.

One embodiment of the method for connecting a radio terminal executed by the radio terminal according to the present invention is a method for connecting a radio terminal in a service area having a first cell and a second cell, executed by the radio terminal for re-selecting a connection with the second cell to a connection with the first cell, the method for connecting a radio terminal comprising: until a communication status of the radio terminal is an idle state and connection to the first cell is determined to be possible, sequentially acquiring an expiration period from a sequence of expiration periods; acquiring the communication status of the radio terminal when the expiration period expires in a timer provided in the radio terminal; if the communication status is an idle state, repeatedly determining whether or not connection to the first cell is possible; and if connection to the first cell is determined to be possible, connecting to the first cell.

One embodiment of the program for controlling a connection according to the present invention is a program for controlling a connection, wherein the program is for making a radio terminal execute the method for connecting a radio terminal described above.

### Effects of Invention

According to the present invention, a primary network can be re-selected, with low power consumption and at high speed, from a partner network that is selected.

### BRIEF DESCRIPTION OF DRAWINGS

FIG. 1A illustrates an example of a service area having a first cell and a second cell to which the radio terminal and the method for connecting a radio terminal according to an embodiment of the present invention are applied.

FIG. 1B is a schematic diagram illustrating an example of overlap between the first cell and the second cell to which the radio terminal and the method for connecting a radio terminal according to an embodiment of the present invention are applied.

FIG. 1C is a schematic diagram illustrating an example wherein a radio terminal in which the second cell is selected re-selects the first cell, to which the radio terminal and the method for connecting a radio terminal according to an embodiment of the present invention are applied.

FIG. 2 is a schematic diagram illustrating an example of a radio terminal according to an embodiment of the present invention.

FIG. 3 is a timing chart for explaining a case in which a timer has expired, and re-selection is performed according to an embodiment of the present invention.

FIG. 4 is a flow chart illustrating an example of a method for connecting a radio terminal according to an embodiment of the present invention.

FIG. 5 is a schematic diagram for comparing the presence and absence of a high-speed re-selection function according to an embodiment of the present invention.

### DESCRIPTION OF EMBODIMENTS

Hereinafter, an embodiment of the present invention will be described in detail with reference to the drawings.

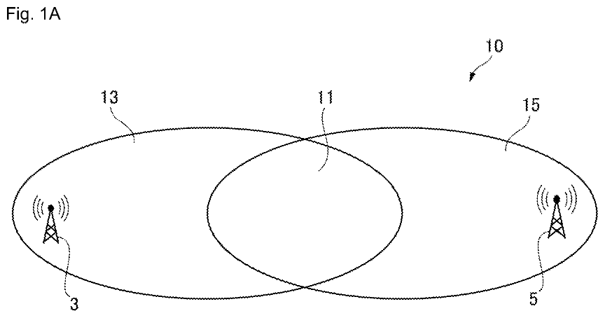

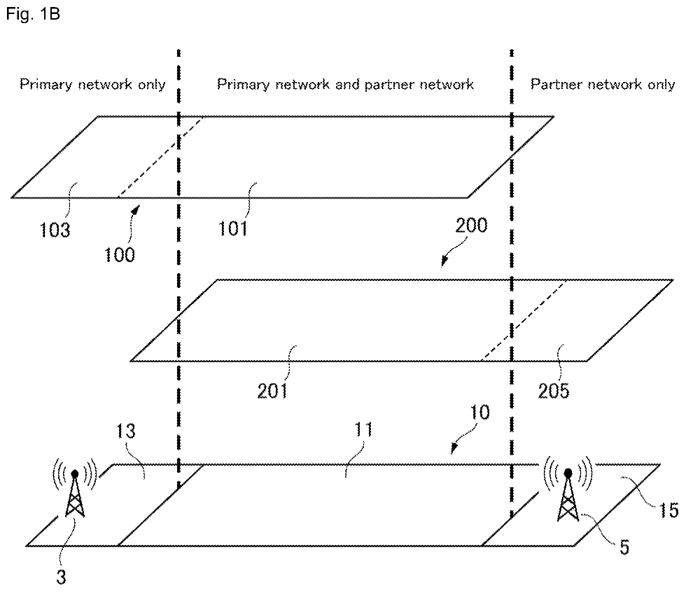

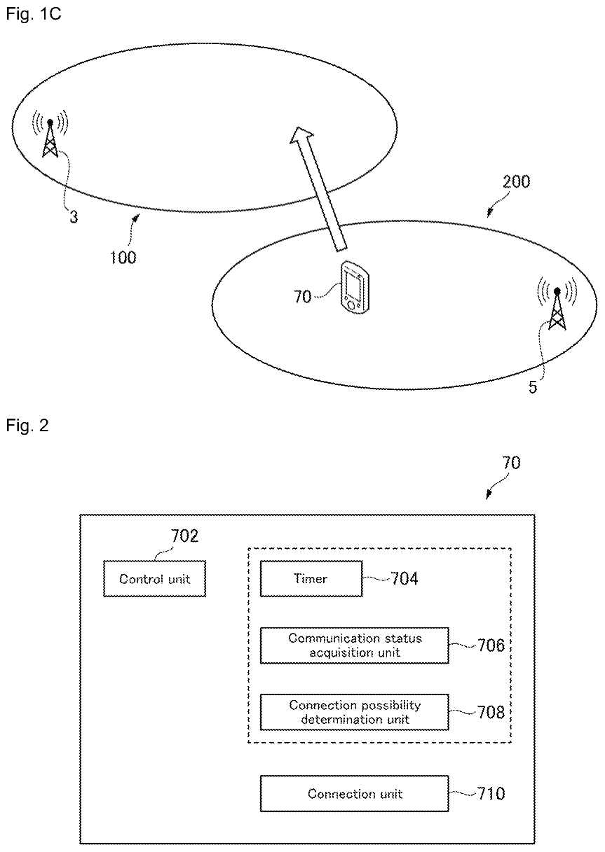

First, cell re-selection will be described with reference to FIG. 1A to 1C. FIG. 1A is an example of a service area 10 having a first cell and a second cell to which the radio terminal and the method for connecting a radio terminal according to an embodiment of the present invention are applied. The service area 10 has a first base station 3 and a second base station 5, respectively forming the first cell and the second cell.

The first cell and the second cell partially overlap in terms of their locations, and in FIG. 1A, the overlap between the first cell and the second cell forms a first area 11. In this first area 11, a radio terminal can communicate with at least one of the first base station 3 and the second base station 5.

On the left side of FIG. 1A, a second area 13 lies outside the cell of the second base station 5. Thus, in this second area 13, the radio terminal can communicate with the first base station 3 but cannot communicate with the second base station 5.

On the right side of FIG. 1A, a third area 15 lies outside the cell of the first base station 3. Thus, in this third area 15, the radio terminal can communicate with the second base station 5 but cannot communicate with the first base station 3.

In the service area 10 as illustrated in FIG. 1A, the first base station 3 belongs to a primary network and the second base station 5 belongs to a partner network. In this case, in the first area 11 and the second area 13, the radio terminal can select and communicate with the cell formed by the first base station 3 of the primary network.

Meanwhile, in the third area 15, the radio terminal cannot select the cell formed by the first base station 3 of the primary network and must select the cell formed by the second base station 5 of the partner network. In other words, even though the radio terminal is supposed to use the primary network, it must make use of roaming communication through the partner network in the third area 15.

FIG. 1B is a schematic diagram illustrating an example of overlap between the first cell and the second cell to which the radio terminal and the method for connecting a radio terminal according to an embodiment of the present embodiment are applied.

In FIG. 1B, for the service area 10 to which the radio terminal and the method for connecting a radio terminal according to an embodiment of the present invention described in FIG. 1A are applied, the cell 100 formed by the first base station 3 of the primary network and the cell 200 formed by the second base station 5 of the partner network are separated in order to explain how the radio terminal is connected.

In FIG. 1B, the cell 100 formed by the first base station 3 of the primary network comprises a first portion 101 corresponding to the first area 11 in which the cell 100 and the cell 200 overlap, and a second portion 103 corresponding to the second area 13 which is outside the cell 200.

Hereinafter, “the radio terminal is in the first portion 101 of the cell 100” means that the radio terminal is positionally located in the first area 11 and is connected to the cell 100. As mentioned above, in the first area 11, the radio terminal can connect to the cell 200 in addition to the cell 100. However, when “the radio terminal is in the first portion 101 of the cell 100”, the cell 100 formed by the first base station 3 of the primary network is assumed to be selected by the radio terminal.

“The radio terminal is in the second portion 103 of the cell 100” means that the radio terminal is positionally located in the second area 13 and is connected to the cell 100. Note that, as mentioned above, in the second area 13, the radio terminal cannot select the cell 200 formed by the second base station 5 of the partner network.

In FIG. 1B, the cell 200 formed by the second base station 5 of the partner network comprises a first portion 201 corresponding to the first area 11 in which the cell 100 and the cell 200 overlap, and a second portion 205 corresponding to the third area 15 which is outside the cell 100.

Hereinafter, “the radio terminal is in the first portion 201 of the cell 200” means that the radio terminal is positionally located in the first area 11 and is connected to the cell 200. As mentioned above, in the first area 11, the radio terminal can connect to the cell 100 in addition to the cell 200. However, when “the radio terminal is in the first portion 201 of the cell 200”, the cell 200 formed by the second base station 5 of the partner network is assumed to be selected by the radio terminal.

“The radio terminal is in the second portion 205 of the cell 200” means that the radio terminal is positionally located in the third area 15 and is connected to the cell 200. Note that, as mentioned above, in the third area 15, the radio terminal cannot select the cell 100 formed by the first base station 3 of the primary network.

FIG. 1C is a schematic diagram illustrating an example wherein a radio terminal in which the second cell is selected re-selects the first cell, to which the radio terminal and the method for connecting a radio terminal according to an embodiment of the present invention are applied. Cell re-selection by the radio terminal 70 regarding the cell 100 formed by the first base station 3 of the primary network and the cell 200 formed by the second base station 5 of the partner network will be described with reference to FIG. 1C.

As described in FIG. 1B, in the first area 11 in which the cell 100 and the cell 200 overlap, the radio terminal 70 can connect to at least one of the cell 100 and the cell 200.

The radio terminal 70 is initially in the first portion 201 of the cell 200 in FIG. 1B. That is, it is assumed that the cell 200 in the first area 11 is selected, and that the partner network is being used.

FIG. 1C illustrates the radio terminal 70, which had selected the cell 200 in the first area 11 in FIG. 1B and which was using the partner network, re-selecting the cell 100 in the same first area 11 in the case in which use of the primary network is preferred.

When the cell 100 is re-selected from the cell 200, the connection destination of the radio terminal is transferred from the second base station 5 to the first base station 3, and the radio terminal 70 uses the primary network.

FIG. 2 is a schematic diagram illustrating an example of the radio terminal 70 according to an embodiment of the invention. The radio terminal 70 comprises a control unit 702 for controlling the re-selection of cells, a timer 704 for measuring the elapsed time period for deciding on a time interval for cell re-selection, a communication status acquisition unit 706 for acquiring the communication status of the radio terminal 70, a connection possibility determination unit 708 for determining whether connection to a re-selection destination cell is possible, and a connection unit 710 for connecting to the re-selection destination cell. Components and the like that are not particularly associated with cell re-selection according to the present invention are omitted from FIG. 2.

When an expiration period set in the timer 704 expires, the radio terminal 70 performs a cell re-selection attempting procedure. More specifically, when the expiration period is set to T1 (the units being, for example, minutes), the cell re-selection attempting procedure is performed when the timer 704 indicates that T1 has elapsed.

By performing the cell re-selection attempting procedure only at the point at which the expiration period expires in the timer 704, the power consumption in the radio terminal can be suppressed, and battery consumption can be prevented. Conversely, constantly determining whether connection is possible regardless of the timer 704 consumes the batteries and is thus disadvantageous.

In the cell re-selection attempting procedure, the communication status of the radio terminal 70 is first acquired by the communication status acquisition unit 706. The communication status that can be acquired by the radio terminal 70 may be “active” or “idle”.

In the case in which the acquired communication status is “idle”, the connection possibility determination unit 708 determines whether or not connection to the re-selection destination cell is possible. For example, in the case in which re-selection from the partner network to the primary network is to be attempted, it may be determined whether or not the radio terminal 70 is receiving sufficiently strong signals from the primary network.

In the case in which the acquired communication status is not “idle”, the control unit 702 determines that connection to a re-selection destination cell is not possible without a determination being performed by the connection possibility determination unit 708.

Alternatively, the connection possibility determination unit 708 may be operated even in the case in which the communication status is not “idle”. However, the control unit 702 determines that connection to the re-selection destination cell is not possible regardless of the result by the connection possibility determination unit 708.

In other words, the control unit 702 performs the procedure for connecting to the re-selection destination cell only in the case in which the acquired communication status is “idle” and connection to the re-selection destination cell has been determined to be possible.

In particular, by performing the cell re-selection procedure only in the case in which the communication status is “idle”, it is possible to avoid disadvantageng the user of the radio terminal, such as by interrupting a voice call or data transmission. Conversely, implementing cell re-selection even when the communication status is “active” can lead to interrupted communication and is thus undesirable.

The control unit 702 repeatedly makes the communication status acquisition unit 706 acquire the communication status of the radio terminal 70 and makes the connection possibility determination unit 708 determine the possibility of connecting to the re-selection destination cell while updating the expiration period in the timer 704 until the communication status is “idle” and the connection possibility determination unit 708 determines that connection to the re-selection destination cell is possible.

In other words, when the communication status is not “idle” or when connection to the re-selection destination cell cannot determined to be possible, the expiration period in the timer 704 is updated and a standby state is again entered until the timer 704 expires. When the timer 704 newly expires, the communication status acquisition unit 706 acquires the communication status of the radio terminal 70 again, and if the communication status is “idle”, then the connection possibility determination unit 708 determines whether connection to the re-selection destination cell is possible.

Updating the expiration period in the timer 704 may involve returning the elapsed time period in the timer 704 to zero and updating the expiration period that was set to a first value T1 to be a second value T2. The expiration period in the timer 704 may be updated repeatedly until a predetermined upper limit number is reached.

When the communication status is “idle” and the connection possibility determination unit 708 determines that connection to the re-selection destination cell is possible, the connection unit 710 terminates the connection to the currently selected cell and connects to the re-selection destination cell.

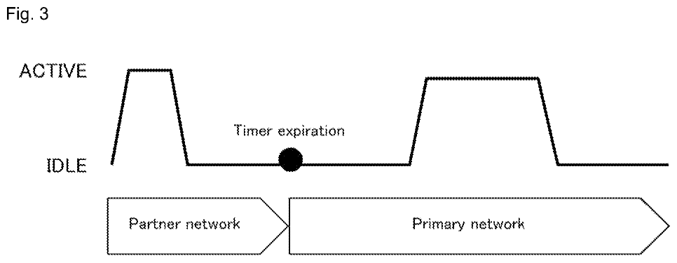

FIG. 3 is a timing chart for describing the case in which the timer has expired, and re-selection is performed according to an embodiment of the present invention. In FIG. 3, the horizontal axis indicates the time, and the vertical axis indicates the communication status of the radio terminal.

FIG. 3 illustrates, as an example, a situation wherein, for a radio terminal using a partner network, the communication status of the radio terminal according to the communication status acquisition unit 706 is “idle” at the time the timer expired, and furthermore, at that time, the connection possibility determination unit 708 has determined that connection to the primary network is possible, and re-selection from the partner network cell to a primary network cell is performed.

The updating of the expiration period in the timer 704 by the control unit 702 may be implemented by sequentially acquiring, as updated expiration periods, the terms in a set numerical sequence (referred to simply as a “sequence of expiration periods”).

For example, if the sequence of expiration periods is the numerical sequence {T1, T2, T3, T4, . . . }, then the expiration periods are acquired sequentially such that the first expiration period is T1, the second expiration period is T2, the third expiration period is T3, and so on. Furthermore, the first communication status is acquired at the time that T1 has elapsed, the second communication status is acquired at the time that T2 has further elapsed after the first communication status was acquired, and so on.

In particular, the sequence of expiration periods may be a sequence in which the numbers become gradually larger. A sequence in which the numbers become gradually larger is a broadly monotonically increasing sequence ({T1≤T2≤T3≤T4≤ . . . }) in which Tn (n being 2 or greater), which is larger than T1, appears somewhere in the sequence.

By acquiring expiration periods from a sequence of gradually increasing numbers in this way, if re-selection becomes possible immediately after starting to attempt re-selection, a cell of the primary network will be re-selected at as early a stage as possible. Meanwhile, if re-selection does not become possible even with repeated attempts, then the power consumed for re-selection can be suppressed by gradually widening the attempt interval.

A preferable sequence of expiration periods is, in units of minutes, {1, 2, 4, 6, 6, 6, (all 6 thereafter)}.

When the timer is instructed to be reset, the updating of the timer expiration period may be performed by returning to the head of the sequence of expiration periods and then following the sequence thereafter. In other words, even if the timer expiration period had been set to Tm (m being 2 or greater) until then, when the timer is instructed to be reset, the timer expiration period is thereafter set to be T1 again, and the expiration periods are then updated to T2, T3, . . . .

The timer may be instructed to be reset when an area code acquired from the base station by the radio terminal is changed. For example, the radio terminal can receive as an area code, from a partner carrier through the base station, a TAC (Tracking Area Code) indicating an area (Tracking Area) in which the radio terminal is located. Since the TAC is changed only when a radio terminal crosses between municipalities, in the case in which the area of a primary network is set in units of municipalities, there can be expected to be a possibility of re-selection of a cell in the primary network when there is a change in the TAC.

Thus, it is efficient to instruct the timer to be reset and to attempt re-selection with the expiration period shortened from a long time period Tm (m being 2 or greater) that was used until then to a short time period T1 when the TAC is changed in the radio terminal.

The timer may be instructed to be reset when power to the radio terminal is switched back on, or when data transmission by the radio terminal, which had been interrupted, is resumed.

For example, when the user of the radio terminal boards an airplane, the user may switch the power of the radio terminal off or the transmission functions may be interrupted by, e.g., setting the radio terminal to airplane mode. Then, when the user disembarks from the airplane, the user switches the power of the radio terminal back on or turns off airplane mode so that the interrupted data transmission by the radio terminal is resumed. Since the departure point and the arrival point are normally located geographically far apart, the possibility of re-selection of cells can also be assumed to be very different, and there can be expected to be a possibility to re-select a cell in the primary network.

Thus, it is efficient to instruct the timer to be reset and to attempt re-selection with the expiration period shortened from a long time period Tm (m being 2 or greater) that was used until then to a short time period T1 when the power to the radio terminal is switched back on or when interrupted data transmission by the radio terminal is resumed.

There are cases in which a radio terminal that has selected a cell in a partner communication network and is performing roaming communication therewith loses the connection with the base station in that partner communication network due to radio wave conditions or the like. In this case, if re-selection of a cell in the primary communication network is preferred, then when connection to a cell in the primary network is determined to be possible, it is advantageous to connect to that cell in the primary network rather than to resume the connection with the base station in the partner communication network.

Additionally, even if connection to a cell in the primary network is not determined to be possible, since the connection with the base station in the partner communication network has been lost, the radio terminal can be assumed to be on the periphery of the cell formed by the base station in the partner communication network. Thus, there is also a higher possibility that a cell in the primary communication network will be re-selected earlier than before.

Therefore, it is efficient to instruct the timer to be reset and to attempt re-selection with the expiration period shortened from a long time period Tm (m being 2 or greater) that was used until then to a short time period T1 when a connection with a base station in a partner communication network has been lost, even if connection to a cell in a primary network is not determined to be possible.

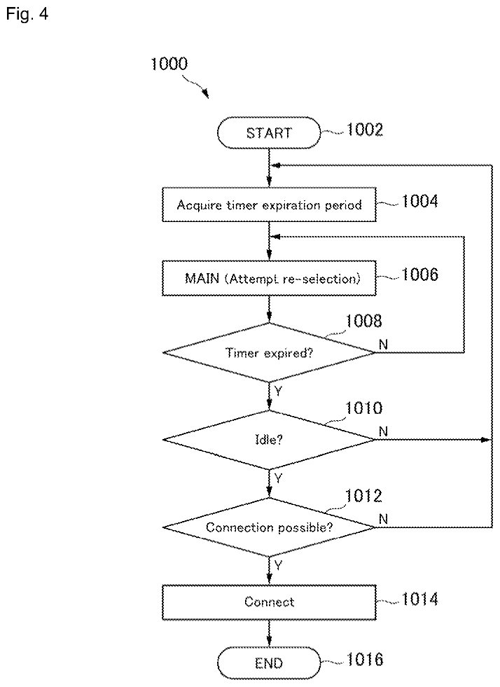

FIG. 4 is a flow chart illustrating an example of a method 1000 for connecting a radio terminal according to an embodiment of the invention. When the radio terminal starts attempting to re-select a cell (1002), a timer expiration time is acquired (1004). In particular, timer expiration times are acquired sequentially from a sequence of expiration periods. Thus, when first starting to attempt cell re-selection, the first value in the sequence is acquired and cell re-selection is attempted (1006).

When the expiration period expires in the timer provided in the radio terminal (1008: Y), the communication status of the radio terminal is acquired to determine whether or not the status is idle (1010). If the acquired communication status is “idle” (1010: Y), then the possibility of connecting to a re-selection destination cell is determined (1012). For example, when attempting re-selection from a partner network to a primary network, the radio terminal may determine whether or not a sufficiently strong signal is being received from the primary network.

If the acquired communication status is not “idle” (1010: N), then it is determined that connection to a re-selection destination cell is not possible without performing a determination regarding the connection possibility (1012), and the procedure returns to acquisition of a timer expiration period (1004).

Note that the signal strength of the primary network may be measured or the like even in the case in which the communication status is not “idle”, though it will be determined that connection to a re-selection destination cell is not possible regardless of the measurement result thereof.

Then, the steps of acquiring the communication status of the radio terminal (1010) and determining the possibility of connecting to a re-selection destination cell (1012) while acquiring updated timer expiration periods (1004) are repeated until the communication status is “idle” and connection to a re-selection destination cell is determined to be possible.

In other words, when the communication status is not “idle” or when connection to a re-selection destination cell cannot be determined to be possible, an updated timer expiration period is acquired (1004), and then, cell re-selection is attempted (1006). In other words, a standby state is again entered until the timer expires. When an expiration period newly expires in the timer (1008: Y), the communication status of the radio terminal is acquired again, and if the acquired communication status is “idle” (1010: Y), then the possibility of connecting to a re-selection destination cell is determined (1012).

If the communication status is “idle” and connection to a re-selection destination cell is determined to be possible (1012: Y), then the connection to the currently selected cell is terminated, the radio terminal is connected to the re-selection destination cell (1014), and the attempts are ended (1016).

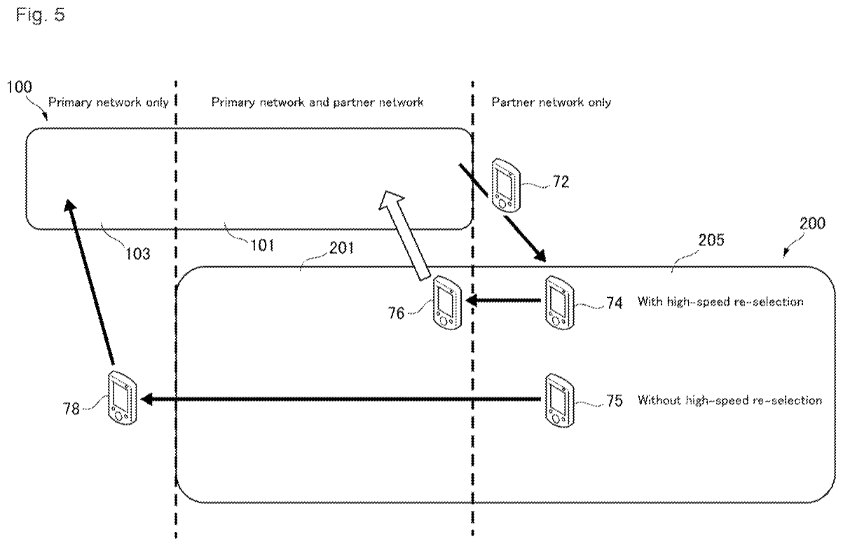

FIG. 5 is a schematic diagram for comparing the presence and absence of a high-speed re-selection function according to an embodiment of the present invention. By referring to FIG. 5, the re-selection according to the present invention can be understood in further detail. In FIG. 5, the radio terminal 72 is in an area in which only a partner network can be used.

For the case in which the radio terminal 72 has the high-speed re-selection function according to the present invention, the state of roaming connection to a cell 200 formed by a second base station of a partner network is represented by the radio terminal 74.

For the case in which the radio terminal 72 does not have the high-speed re-selection function according to the present invention, the state of roaming connection to a cell 200 formed by a second base station of a partner network is represented by the radio terminal 75.

Even if the radio terminal 75 not having the high-speed re-selection function according to the present invention has moved and arrived at a location at which a cell 100 formed by a first base station of a primary network overlaps with the cell 200 formed by the second base station of the partner network, the re-selection function according to the present invention will not immediately be activated.

The roaming connection to the cell 200 continues without, in particular, acquiring the communication status by making use of the timer and determining the possibility of connection. The roaming connection to the cell 200 is terminated when the radio terminal 75 leaves the cell 200 and moves to a location contained in the cell 100, as represented by the radio terminal 78.

In contrast therewith, the radio terminal 76 represents the state wherein the radio terminal 74 having the high-speed re-selection function according to the present invention has moved and arrived at a location at which the cell 100 formed by the first base station of the primary network overlaps with the cell 200 formed by the second base station of the partner network.

Since the radio terminal 76 has the high-speed re-selection function, when the timer expires, if the communication status is “idle”, then the re-selection function is activated because the radio terminal 76 is at a location at which connection to the cell 100 formed by the first base station of the primary network is possible. Then, the selection of the cell 200 is terminated and the cell 100 formed by the first base station of the primary network is re-selected. Furthermore, the roaming connection to the cell 200 is also terminated.

Furthermore, the present invention also comprises a program for controlling a connection, wherein the program is for making a radio terminal execute the method for connecting a radio terminal described above.

As described above, according to the present invention, roaming communication with a partner network can be terminated and a primary network can be re-selected with low power consumption and at high speed.

The present invention is not limited to the embodiments described above and comprises various modified examples in which constituent elements have been added, removed, or replaced with respect to the configurations indicated above.

### REFERENCE SIGNS LIST

3 First base station
5 Second base station
10 Service area
11 First area
13 Second area
15 Third area
100, 200 Cell
101, 201 First portion
103, 205 Second portion
70, 72, 74, 75, 76, 78 Radio terminal
702 Control unit
704 Timer
706 Communication status acquisition unit
708 Connection possibility determination unit
710 Connection unit

1. A radio terminal that operates in a service area having a first cell and a second cell, the radio terminal comprising:
a timer;
a communication status acquisition unit that acquires a communication status of the radio terminal when an expiration period expires in the timer;
a connection possibility determination unit that determines whether or not connection to the first cell is possible if the communication status is an idle state;
a control unit that sequentially acquires the expiration period from a sequence of expiration periods and that repeatedly operates the communication status acquisition unit and the connection possibility determination unit until the communication status is in an idle state and connection to the first cell is determined to be possible; and
a connection unit that connects to the first cell if connection to the first cell is determined to be possible.

2. The radio terminal according to claim 1, wherein the sequence of expiration periods is a sequence in which numbers become gradually larger.

3. The radio terminal according to claim 2, configured so that, if the timer is instructed to be reset, the acquisition of the expiration periods is performed sequentially after returning to the head of the sequence of expiration periods.

4. The radio terminal according to claim 3, configured so that the timer is instructed to be reset when an area code acquired from a base station is changed.

5. The radio terminal according to claim 3, configured so that the timer is instructed to be reset when power to the radio terminal is switched back on.

6. The radio terminal according to claim 3, configured so that the timer is instructed to be reset when data transmission by the radio terminal is resumed.

7. The radio terminal according to claim 3, configured so that, when a connection between the radio terminal and the second cell is lost,
if connection to the first cell is determined to be possible, the radio terminal is connected to the first cell, and
if connection to the first cell is not determined to be possible, the timer is instructed to be reset.

8. A method for connecting a radio terminal in a service area having a first cell and a second cell, executed by the radio terminal for re-selecting a connection with the second cell to a connection with the first cell, the method for connecting a radio terminal comprising:
until a communication status of the radio terminal is an idle state and connection to the first cell is determined to be possible,
sequentially acquiring an expiration period from a sequence of expiration periods;
acquiring the communication status of the radio terminal when the expiration period expires in a timer provided in the radio terminal;
if the communication status is an idle state, repeatedly determining whether or not connection to the first cell is possible; and
if connection to the first cell is determined to be possible, connecting to the first cell.

9.-15. (canceled)
